(19) United States
(12) Patent Application Publication
(10) Pub. No.: US 2009/0162069 A1
(43) Pub. Date: Jun. 25, 2009

(54) Apparatus and Method of Optical Communication

(75) Inventor: Per Magnusson, Linkoping (SE)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/959,777

(22) Filed: Dec. 19, 2007

(51) Int. Cl. H04B 10/00

(52) U.S. Cl. 398/106

(57) ABSTRACT

An optical communication apparatus includes an optical source and electronic control circuitry configured to generate a burst of heterogeneous pulses. The burst of heterogeneous pulses includes pulses within a band of characteristic pulse frequencies. The electronic control circuitry is further configured to transmit a plurality of the burst from the optical source in a pattern corresponding to data to be transmitted.

### BACKGROUND

Optical beams have long been used to communicate data between electronic devices. For example, optical beams are commonly used in remote control devices for television sets, audio systems, video reproduction devices and projectors. Data may be transmitted between electronic devices optically by modulating the data onto an optical beam. This may be done, for example, by selectively altering the wavelength, intensity, period, and/or time-related elements of the optical beam to represent the data being transmitted. The modulated optical beam may then be transmitted to an optical detector in a recipient electronic device, where the beam is then demodulated and the encoded data retrieved.

Optical energy in the infrared portion of the spectrum is particularly popular in many areas of wireless communication technology. In fact, the majority of remote control devices in use today utilize infrared light emitting diodes (LEDs) to transmit modulated optical energy to corresponding infrared detectors. Additionally, many personal computers and electronic devices include complementary infrared ports for the transmission of files from one device to another.

This seeming ubiquity of infrared devices is partially due to economic reasons. Many infrared transmitters and detectors are fairly simple to manufacture and can be produced at a relatively low cost. Moreover, infrared optical energy may be more easily distinguished from ambient optical energy than can a modulated visible light beam. Consequently, a modulated infrared beam is less susceptible to interference from ambient optical energy than modulated visible light.

However, infrared optical transmitters and receivers are not immune to all types of optical interference. For example, many optical communication protocols involve the use of substantially uniform bursts of optical energy. These bursts are often of a fixed frequency and fixed length, with data being modulated onto the optical beams according to the timing between bursts transmitted or the amplitude of the optical energy in the bursts. Systems using this type of modulation may be susceptible to interference caused by high frequency flicker from light sources such as flat-panel television screens or fluorescent lighting tubes with high frequency ballasts. This interference can be particularly detrimental to optical communications when it includes a frequency component substantially similar to the fixed frequency of the optical bursts.

Clearly, interference in optical communication devices can be rather inconvenient to a user. The interference may contribute to the corruption of data transmitted from one device to another, sometimes without the knowledge of the user. In other scenarios, a user may have to repeat the transmission of data from one device to another after an initial transmission attempt is disrupted or corrupted by external interference.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a perspective diagram of an illustrative system utilizing optical communication.

FIG. 2 is a block diagram of an illustrative system utilizing optical communication.

FIG. 3 is a diagram of an illustrative optical pulse burst sequence having a fixed characteristic frequency and pulse length.

FIG. 4 is a diagram an illustrative optical pulse burst sequence having a band of a plurality of characteristic frequencies and pulse lengths.

FIG. 5 is a diagram of an illustrative frequency component plot of an optical pulse burst sequence having a substantially fixed characteristic frequency and pulse length.

FIG. 6 is a diagram of an illustrative frequency component plot of an optical pulse burst sequence having a band of a plurality of characteristic frequencies and pulse lengths.

FIG. 7 is a diagram of an illustrative optical pulse burst sequence being used to modulate data in an exemplary modulation scheme.

FIG. 8 is a diagram of a more detailed view of a portion of the illustrative optical pulse burst sequence shown in FIG. 7.

FIG. 9 is a diagram of an illustrative optical pulse burst sequence in which an inverse pulse burst is transmitted during periods of time when the pulse burst is not being transmitted.

FIG. 10 is a block diagram of an illustrative optical transmitter.

FIG. 11 is a block diagram of an illustrative optical receiver.

FIG. 12 is a block diagram of an illustrative method of optical communication.

Throughout the drawings, identical reference numbers designate similar, but not necessarily identical, elements.

### DETAILED DESCRIPTION

To address the issues posed by optical interference that can potentially disrupt, distort, or corrupt wireless optical communications between two electronic devices, the present specification describes novel methods and systems providing for optical communications that are less susceptible to noise interference. As described herein, the system may enhance the quality of optical communications between electronic devices and present a more favorable experience to an end user or owner of an electronic device.

As described herein, bursts of optical energy are timed according to a modulation protocol to convey data. Depending on when the burst occurs in a regular time cycle, certain data bits are represented. The receiver must then distinguish the burst and its location in the time cycle from any ambient interference so as to receive the data transmitted. According to principles disclosed herein, the burst may include pulses of optical energy with a frequency spectrum over a particular characteristic band of frequencies. Any ambient interference is highly unlikely to include optical pulses with a similar or similarly broad frequency spectrum as that used by the electronic devices for optical communication. Consequently, the receiving device can more surely identify the bursts being used to transmit data, record the timing of those bursts and, consequently, decode the data being transmitted.

As used in the present specification and in the appended claims, the term “pulse” refers to a single cycle of activating an optical source such that optical energy is emitted from the optical source, and subsequently deactivating the optical source. The term “pulse,” as defined herein, may also refer to electronic data corresponding to characteristics of the activation/deactivation cycle.

As used in the present specification and in the appended claims, the term “burst” refers to a sequence of pulses as defined herein. The component pulses in any given burst, as presently defined, need not be of the same duration, amplitude, or duty cycle.

As used in the present specification and in the appended claims, the term “optical energy” refers to radiated energy having a wavelength generally between around 400 nanometers to 1500 nanometers. Optical energy as thus defined includes, but is not limited to, ultraviolet, visible and infrared light. A beam of optical energy may be referred to herein as a “light beam” or “optical beam.” Some embodiments described herein will use infrared light with a wavelength between 900 and 1000 nanometers.

As used in the present specification and in the appended claims, the term “optical source” refers to a device from which optical energy originates. Examples of optical sources as thus defined include, but are not limited to, light emitting diodes, lasers, light bulbs, and lamps.

As used herein and in the appended claims, the term “independent characteristic frequency” is used to refer to a frequency component in a burst of pulses, where none of the independent frequency components is a whole number multiple of any other independent frequency component.

As used herein and in the appended claims, the term “time cycle” refers to a repeating period of time of a specific length, where each of the periods of time is divided into a regular number of time increments. Consequently, a time cycle may also be referred to as a “time increment group.” Specific bits of data are then correlated to each of the time increments within a time cycle, such that those bits of data are recognized and received by a receiving device if a burst from an optical transmitter in the transmitting device is detected in that corresponding time increment within the cycle or time increment group

To overcome the issues described above, the present specification discloses various embodiments of systems that allow optical communication between two or more electronic devices with minimal susceptibility to optical interference. Some of these embodiments may include an optical source and electronic circuitry configured to generate a burst of heterogeneous pulses having a frequency spectrum spanning a particular band of frequencies. The electronic control circuitry may be further configured to transmit a plurality of bursts from the optical source within a time cycle, where the bursts are timed in a pattern corresponding to data to be transmitted.

Additionally, the present specification discloses a method of optical communication, including the steps of providing a preconfigured burst of heterogeneous pulses and transmitting a plurality pulses of the preconfigured burst from an optical source in a pattern corresponding to data to be transmitted. The preconfigured burst of heterogeneous pulses may have a frequency spectrum spanning a band of frequencies.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to exemplary systems and methods of optical communication.

### Illustrative Systems

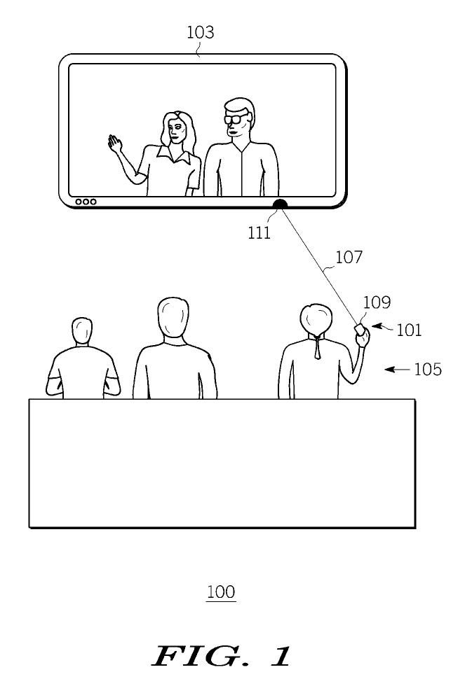

Referring now to FIG. 1, an illustrative system (100) of optical communication is shown according to the principles described herein. The illustrative system (100) includes a first electronic device (101) and a second electronic device (103). The first electronic device (101) and the second electronic device (103) may be in optical communication, such that data may be exchanged between the first and second electronic devices (101, 103).

In the illustrated example, the first electronic device (101) is a remote control device configured to at least partially control the operations of the second electronic device (103), which is shown in the present example as a television set or similar display device. The first electronic device (101) of the present embodiment may be configured to control the operations of the second electronic device (103) upon response to input from a user (105). The input from the user (105) may trigger the transmission of data from the remote control device (101) to the second electronic device (103) on a modulated optical beam (107).

In the illustrated embodiment, for instance, the user (105) may desire to change a certain aspect of the content being displayed on the second electronic device (103), for example, by changing a channel being displayed, switching to another content source, adjusting volume settings, adjusting display settings, and/or selecting other available options. This change may be effected by the user (105) pressing one or more buttons or otherwise interacting with the remote control device (101). The user interaction with the remote control device (101) may cause the first electronic device (101) to transmit a data command to the second electronic device (103) using the modulated optical beam (107).

The modulated optical beam (107) may originate at an optical source (109) component of the remote control device (101). The beam (107) is then directed and transmitted to an optical receiver (111) of the second electronic device (103).

In some embodiments, where a complementary remote control device and television set or display device are not necessarily used, the first electronic device (101) and the second electronic device (103) may include any electronic devices equipped for optical communication with each other, as may suit a particular application. For example, the first and second electronic devices (101, 103) may be selected from the group of electronic devices including, but not limited to, personal computers, personal digital assistants (PDAs), mobile telephones, display devices, remote control devices, other computing devices, other personal electronic devices, and combinations thereof.

In some embodiments, optical sources (109) may include light emitting diodes and/or laser sources, such as vertical cavity surface emitting lasers or standard diode lasers. Likewise, optical receivers (111) may include photodiodes, photoresistors or other optical sensors. The optical sources (109) may be especially configured to emit optical energy having a certain characteristic wavelength or band of characteristic wavelengths, such as optical energy in the infrared spectrum. Additionally, the optical receivers (111) may be especially configured to detect optical energy having the certain characteristic wavelength or band of characteristic wavelengths emitted by the corresponding optical source (109). To this end, optical filters may be employed in conjunction with the optical sources (109) and/or the optical receivers (111) to define the wavelength or band of wavelengths used for optical communication.

Moreover, the first and second electronic devices (101, 103) need not necessarily be configured such that optical communication is originated between electronic devices (101, 103) only as a result from user input. In some embodiments, optical communication may be initiated between the electronic devices (101, 103) automatically or on an “as needed” basis. Furthermore, optical communication between the electronic devices (101, 103) need not necessarily be limited to relaying commands from one of the electronic devices (101, 103) to another of the electronic devices (101, 103). For example, data produced or stored by one of the electronic devices (101, 103) may be transmitted optically to another of the electronic devices (101, 103) according to the functional requirements of a particular application.

Data exchange between electronic devices (101, 103) may be bilateral in some embodiments and unilateral in other embodiments. In embodiments involving bilateral optical transmission of data, each of the electronic devices (101, 103) may include its own optical source (109) and optical receiver (111). In other embodiments, each of the electronic devices (101, 103) may only include an optical source (109) or an optical receiver (111) as best suits that application.

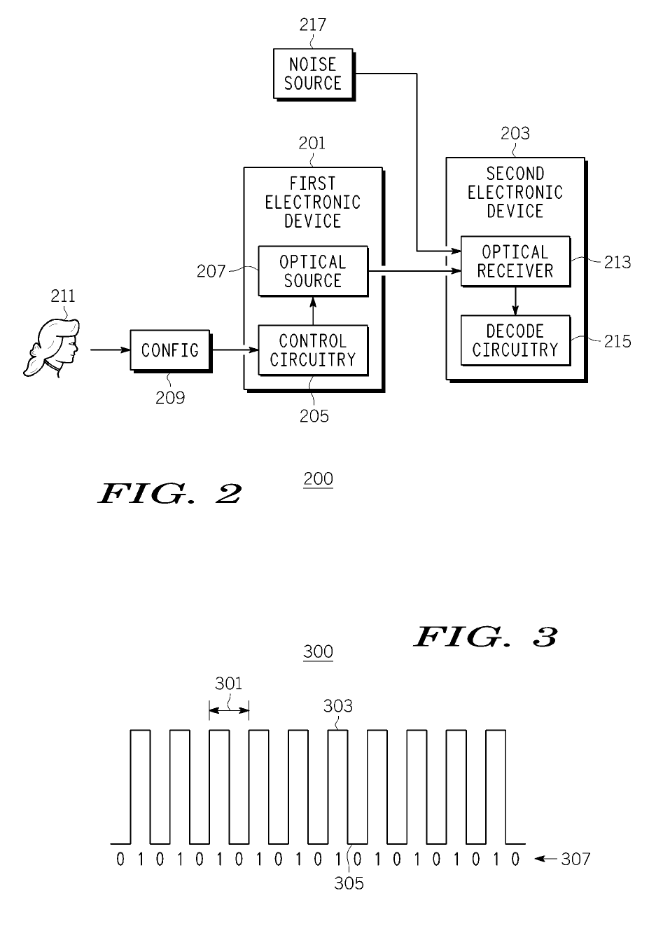

Referring now to FIG. 2, a block diagram of an illustrative system (200) of optical communication is shown. The illustrative system (200) includes a first electronic device (201) configured to optically communicate with a second electronic device (203).

The first electronic device (201) includes control circuitry (205) and an optical source (207). The control circuitry (205) may be configured to selectively activate and deactivate the optical source (207) such that data is encoded on an optical beam produced by the source (207) and transmitted optically to an optical receiver (213) in the second electronic device (203) according to a desired modulation protocol. The data may then be demodulated using decode circuitry (215) in the second electronic device (203). For example, the control circuitry (205) may include a burst modulator. The control circuitry (205) may include one or more processing elements, such as microcontrollers, computer processors, application specific integrated circuits (ASICs), Field Programmable Gate Arrays (FPGAs), Complex Programmable Logic Devices (CPLDs) and/or other processing elements as may suit a particular application.

As explained above, the optical source (207) and optical receiver (213) may be configured to communicate using optical energy of a certain characteristic wavelength or band of characteristic wavelengths, such as infrared optical energy. For this reason, specialized optical sources (207), optical receivers (213), and/or associated optical filters may be present in the first and second electronic devices (201, 203).

In the present illustrated example, the control circuitry (205) may be configured to receive configuration data (209) from a user (211). The configuration data (209) may directly affect the data that is transmitted optically to the second electronic device (203). For example, the configuration data (209) may include the actual data that is to be transmitted optically to the second electronic device (203) by the first electronic device (201). In such embodiments, the control circuitry (205) may be configured to translate the configuration data (209) received from the user (211) into a format that may be modulated according to a desired modulation scheme and/or interpreted by the second electronic device (203).

As mentioned above, the optical receiver (213) of the second electronic device (203) may also receive optical energy from an exterior noise source (217). The optical energy received from the exterior noise source (217) may include optical energy having the same characteristic wavelength and/or band of characteristic wavelengths utilized by the optical source (207) to transmit data, e.g., infrared. Under such circumstances, the optical energy from the noise source (217) detected by the optical receiver (213) may detrimentally interfere with optical energy transmitted from the first electronic device (201) that is modulated with data intended for the second electronic device (203).

This may be especially true in optical systems utilizing a modulation scheme that involves on-off pulses of optical energy of a fixed frequency, due to the fact that high-frequency flicker may occur in a potential optical noise source (217), such as a flat screen television and fluorescent lighting tubes with high-frequency ballasts. This flicker may correspond to the pulse frequency for optical communication. Consequently, even when signal processing filters are employed with an optical receiver (213), high-frequency flicker from a noise source (217) may interfere with the data-bearing optical signal if the pulses of optical energy from the noise source (217) have substantially the same frequency as the fixed-frequency pulses used in for data communication. In such cases, a signal processing filter may not be able to differentiate between optical energy received from the first electronic device (201) and optical energy received from the noise source (217).

To overcome these limitations, the control circuitry (205) in the first electronic device (201) may be configured to modulate data onto optical energy emitted by the optical source (207) using a preconfigured burst of heterogeneous pulses. This burst may include pulses having a frequency spectrum spanning a particular characteristic band of frequencies, rather than a single fixed frequency. Consequently, the data-bearing burst of the optical system is much less likely to be approximated by, and thus interfered with, by noise from nearby noise sources (217). Thus, the electronic control circuitry (205) of the first electronic device (201) may be configured to generate the preconfigured burst and then optically modulate the data by transmitting a plurality of the burst from the optical source (207) over the course of a repeating time cycle in a pattern corresponding to the data to be transmitted.

The optical receiver (213) may be configured to receive the data transmission from the optical source (207) using a filter customized to detect instances of the preconfigured burst in detected optical energy. Due to the multiple frequency-related components of the preconfigured burst, the burst can be more readily identified without ambient noise being erroneously taken for a signal burst, and the second electronic device (203) may therefore be better equipped to decode the data transmission from the first electronic device (201). This will be described in more detail below.

As described above, the receiving electronic device must distinguish pulse bursts from ambient noise. The timing of the bursts within a time cycle then indicates the data being transmitted. FIG. 3 illustrated a pulse burst having a single characteristic frequency, which, as explained herein, can be approximated by a nearby noise source. FIG. 4 illustrates a pulse burst according to principles disclosed herein having pulses with a frequency spectrum spanning a particular characteristic band of frequencies so as to be more readily distinguished from ambient noise.

Referring now to FIG. 3, a fixed-frequency pulse burst (300) is shown. The burst (300) may include a plurality of substantially rectangular, identical pulses (301) that are transmitted consecutively for a fixed amount of time. Each of the pulses (301) may include an “on” portion (303) and an “off” portion (305). The “on” portion (303) may correspond to a period of time in which the optical source (207, FIG. 2) of a transmitting electronic device (201, FIG. 2) is switched on and transmitting optical energy to a corresponding optical receiver (213, FIG. 2) in a receiving electronic device (203, FIG. 2). Likewise, the “off” portion (305) may correspond to a period of time in which the optical source (207, FIG. 2) of a transmitting electronic device (201, FIG. 2) is switched off.

Each of the pulses (301) in the present burst (300) may be of an approximately equivalent duration to the other pulses (301) in the burst (300), and each of the pulses (301) may have a substantially equivalent duty cycle. This establishes a substantially uniform characteristic frequency for the burst (300). Data may be transmitted to a receiving device (203, FIG. 2) by transmitting a plurality of these bursts (300) with an optical source (207, FIG. 2).

In digital systems, a burst vector (307) may be used to characterize the nature of the pulse burst (300). The burst vector (307) may include a sequence of ones and zeros corresponding to the status of an optical source (207, FIG. 2) at regular intervals of time. In the present example, a zero may correspond to the optical source (207, FIG. 2) in a deactivated state, while a one may correspond to the optical source (207, FIG. 2) that is activated and transmitting optical energy. The regularity with which the ones and zeros alternate on and off in the burst vector (307) may be an indication of the regularity of the pulse burst (300). Hence, the very regular pattern of alternating zeros and ones in the burst vector (307) may be an indication of a substantially fixed characteristic frequency in the pulse burst (300).

Referring now to FIG. 4, an illustrative burst (400) comprised of heterogeneous pulses (401, 403) is shown. The pulses (401, 403) may be substantially rectangular and transmitted consecutively. Similar to previous embodiments, each of the pulses (401, 403) may include an “on” portion (405) corresponding to a period of time in which an optical source (207, FIG. 2) is activated, and an “off” portion (407) corresponding to a period of time in which an optical source (207, FIG. 2) is deactivated. Unlike the burst described above with reference to FIG. 3, the illustrative burst (400) of FIG. 4 may have a frequency spectrum spanning a band of frequencies. In this way, the burst (400) is much more easily distinguished from noise caused by nearby optical sources because such noise is unlikely to be closely correlated with the transmitted burst. Thus, data that may be transmitted using the illustrative burst (400) in a modulation scheme may be less susceptible to interference from exterior optical noise sources.

As noted above, the pulses (401, 401) of the burst (400) including pulses of varying pulse lengths. These pulse lengths may determine the frequency-related aspects of the illustrative burst (400). For example, by varying one or more of the heterogeneous pulse lengths the frequency-related components of the illustrative pulse burst (400) may be adjusted as suits a particular application. For example, pulses of a first length will occur at a first frequency in the burst (400), while pulses of a second length will occur at a second independent frequency within the burst (400).

A burst vector (409) is shown for the illustrative pulse burst (400). As described above, the burst vector (409) may include a sequence of ones and zeros corresponding to the status of an optical source (207, FIG. 2) at regular intervals of time. In the present example, a zero may indicate that the optical source (207, FIG. 2) is in a deactivated state, while a one may indicate that the optical source (207, FIG. 2) is activated and transmitting optical energy. The regularity with which the ones and zeros alternate in the burst vector (409) may be an indication of the regularity of the pulse burst (400). As can be seen in the present example, the burst vector (409) of a pulse burst (400) of heterogeneous pulse lengths may not exhibit a very high degree of regularity in alternating between ones and zeros due to the multiple characteristic frequencies in the burst (400).

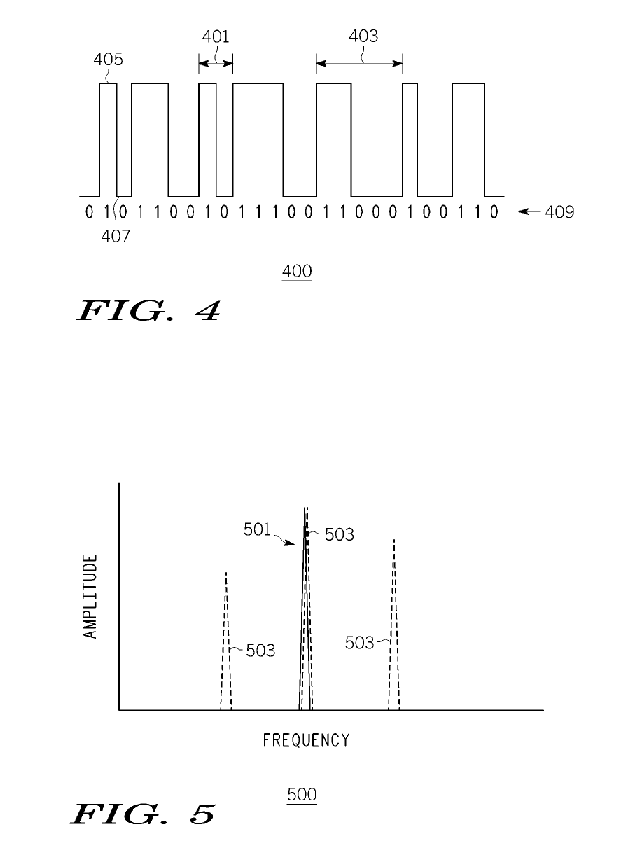

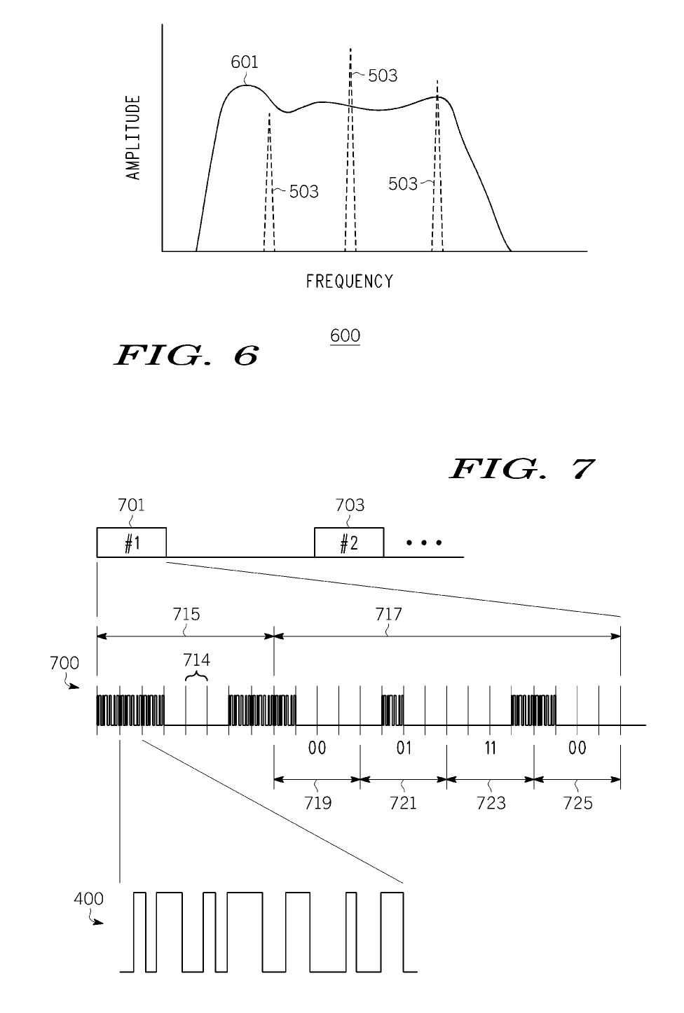

Referring now to FIGS. 5 and 6, illustrative depictions of the exemplary pulse bursts (300, 400; FIGS. 3 and 4) described previously are shown here in the frequency domain. FIG. 5 shows a frequency domain depiction (500) of a fixed-frequency pulse burst and FIG. 6 shows the frequency domain depiction (600) of a heterogeneous pulse burst.

In each of FIGS. 5 and 6, the horizontal axis represents frequency, and the vertical axis represents the amplitude or occurrence of the range of frequencies represented along the horizontal axis. Therefore, plots of a substantially fixed-frequency pulse burst (501) and a heterogeneous pulse burst (601) illustrate the intrinsic frequency related characteristics of each of the pulse burst shapes. For example, the plot in FIG. 5 depicts a very narrow band of frequency-related components in the fixed-frequency pulse burst (501). The plot in FIG. 6, on the other hand, depicts a much wider band of frequency-related components in the heterogeneous pulse burst (601).

As shown in FIGS. 5 and 6, a wider plot in these frequency domain depictions of the illustrative pulse bursts (501, 601) may illustrate a wider range of characteristic frequencies present in the pulse bursts (300, 400; FIGS. 3-4). A wider range of characteristic frequencies present in a pulse burst may inversely correlate with the susceptibility to optical noise of optical energy modulated into the pulse burst. This may be seen when a frequency domain plot of illustrative noise (503) is shown in comparison to each of the plots (501, 601) of the illustrative pulse bursts (300, 400; FIGS. 3-4). In these graphs, the extent to which the plot of the illustrative noise (503) overlaps the frequency domain plots of the different pulse burst shapes may be an indication of the degree to which interference caused by the illustrative noise (503) is detrimental to the transmission of data using the indicated pulse burst shape.

The illustrative noise (503) may contain frequency components identical or similar to that of the fixed-frequency pulse burst (501). When this is the case, the plot of the illustrative noise (503) may substantially overlap the area covered by the plot of the fixed-frequency pulse burst (501). This may indicate that an electronic band-pass filter in a receiving electronic device may not be able to distinguish between data modulated using the pulse burst (501) and the illustrative noise (503), which may corrupt or disrupt data transmission

As shown in FIG. 6, however, the plot of the illustrative noise (503) overlaps a relatively small proportion of the total area covered by the plot of the illustrative heterogeneous pulse burst (601) spanning a range of frequencies. Furthermore, the phase characteristics of the heterogeneous pulse burst are unlikely to be similar to that of the noise. This may indicate that a filter configured to detect instances of the heterogeneous pulse burst (601) may be better equipped to differentiate between data modulated using the heterogeneous pulse burst (601) and the illustrative noise (503).

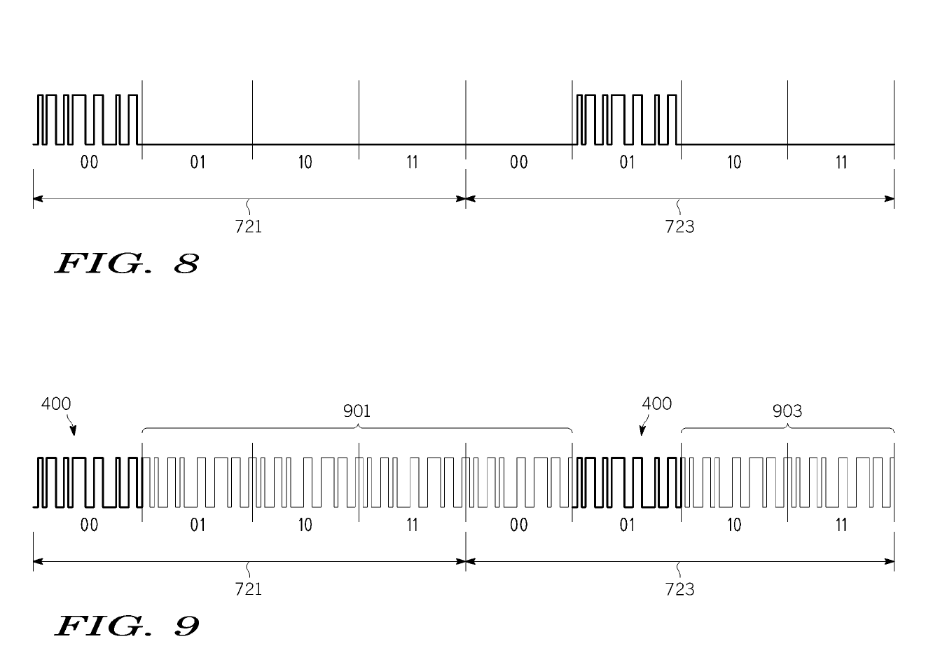

Referring now to FIGS. 7 and 8, an exemplary optical modulation scheme (700) using the illustrative multi-frequency pulse burst (400) is shown. The exemplary modulation scheme (700) uses burst position modulation to encode the bits of data packets (701, 703) that are transmitted sequentially from an optical source to an optical receiver. However, the principles described herein may be used with any modulation scheme which uses pulse bursts of a fixed time duration or multiples of a fixed time duration to encode data onto optical energy, as may suit a particular application. For example, suitable modulation schemes may include, but are not limited to, Manchester coding, biphase mark coding, pulse position coding and combinations thereof.

As used in the present example, each packet (701, 703) in the burst position modulation scheme may include a plurality of bursts within a time cycle, where the bursts are of the nature described above with respect to illustrative optical pulse burst (400, FIG. 4). Due to the fact that each pulse burst (400) may be substantially of the same duration, data may be modulated onto an optical beam using by dividing a predetermined amount of time, i.e., a time cycle, into smaller increments (714) and determining whether one of the illustrative pulse burst (400) has been transmitted within each of the smaller increments (714).

In the illustrative modulation scheme shown, each of the packets (701, 703) may be divided into a header portion (715) and a payload portion (717). The positioning of optical pulse bursts (705) within the increments (714) of the header portion (715) may be used to provide packet information and/or synchronization data to a receiving device. The payload portion (717) may be used for the main transmission of data in the packet (701). Digital data including ones and zeros may be retrieved from the packet (701) according to the presence of optical pulse bursts (400) within the time increments (714) of the payload portion (717).

For example, as shown in FIG. 7, the payload portion (717) of a packet (701) may include a number of time cycles or time increment groups (719, 721, 723, 725), wherein each of the cycles or time increment groups (719, 721, 723, 725) may include the same number of consecutive time increments (714). In the illustrated example, each of the time increment groups (719, 721, 723, 725) includes four consecutive time increments (714). Each of the time increments (714) within a time increment group (719, 721, 723, 725) may correspond to a different two-digit binary value. For example, the first time increment (714) may correspond to a digital value of “00,” the second time increment (714) may correspond to a digital value of “01,” the third time increment (714) may correspond to a digital value of “10,” and the fourth time increment (714) may correspond to a digital value of “11.”

In FIG. 8, a closer view of time increment groups (721, 723) is shown. The digital data transmitted by each of the time increment groups (719, 721, 723, 725) may be decoded by evaluating which of the increments (714) in each of the groups (719, 721, 723, 725) is utilized by an optical source for the transmission of an optical pulse burst (400). For example, as shown in FIG. 7, time increment group (719) may be configured to transmit a “00,” as an optical pulse burst (400) is present within the first time increment (714) of the time increment group (719). Likewise, time increment group (721) may be configured to transmit a “01,” as an optical pulse burst (400) is present within the second time increment (714) of the time increment group (721).

In the same manner, time increment group (723) may be configured to transmit “11,” and time increment group (725) may be configured to transmit “00,” as shown in FIG. 7. It is to be understood that in such a modulation scheme, any suitable time division or grouping of time increments (714) may be used as fits a particular application.

As shown in FIGS. 7 and 8, during time increments (714) in which an optical pulse burst (400) is not being transmitted, an optical source may be deactivated such that optical energy may not be transmitted to an optical receiver. Such embodiments may help conserve power at a transmitting electronic device.

Referring now to FIG. 9, an alternate embodiment is shown in which an inverse (901) of the pulse burst (400) is transmitted during periods of time (903, 905) in which the optical pulse burst (400) is not transmitted. By transmitting the inverse (901) of the pulse burst (400), the signal to noise ratio at the receiving electronic device may be further improved, in some embodiments, by enabling an optical or signal processing filter to more easily differentiate between the pulse burst (400) and periods (903, 905) in which the pulse burst (400) is not being transmitted.

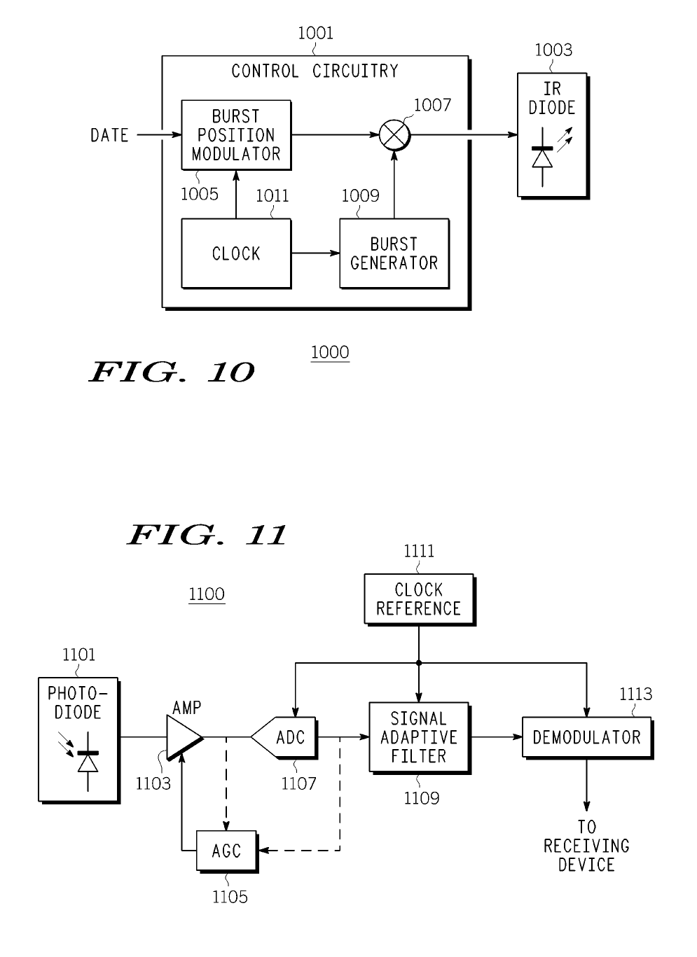

Referring now to FIG. 10, a block diagram of an illustrative embodiment of an optical transmitter (1000) is shown. As will be appreciated by those skilled in the art, some of the blocks in FIG. 10 can be implemented in software, hardware or a combination thereof.

As shown in FIG. 10, the optical transmitter (1000) may be configured to receive a stream of digital data and modulate the data onto a beam of optical energy. In the present example, the illustrative optical transmitter (1000) may be configured to use a burst position modulation scheme to modulate the data onto the beam of optical energy. Variations may be made in the components and/or functions thereof as may suit a particular application.

The optical transmitter (1000) may include electronic control circuitry (1001) in communication with an optical source (1003). In the present example, the optical source (1003) is an infrared diode. However, in other embodiments any suitable optical source may be used, as explained previously.

The electronic control circuitry (1001) may be configured to generate a burst of heterogeneous pulses, such that each burst includes pulses having a frequency spectrum spanning a particular band of frequencies, according to the principles described herein. In some embodiments, the burst may include many independent characteristic frequencies to provide the signal emitted by the optical source (1003) with less susceptibility to ambient sources of optical noise that may degrade or corrupt the data modulated onto the signal. In some embodiments, the function of generating the burst of heterogeneous pulses may be performed by a burst generator module (1009).

The electronic control circuitry (1001) may be further configured to transmit a number of the generated bursts from the optical source (1003) in a time-cycle pattern corresponding to data to be transmitted. In optical transmitters (1000) utilizing burst position modulation, a burst position modulator (1005) may output a digitally high signal during time increments in which a burst is to be transmitted according to the particular modulation scheme used.

A multiplier (1007) may be operably connected to both the burst position modulator (1005) and the burst generator (1009) such that the burst of heterogeneous pulses is output to the optical source (1003) during time increments when the burst position modulator (1005) is outputting a digitally high signal. A clock module (1011) may be present in the control circuitry (1001) to provide timing information to the burst position modulator (1005) and the burst generator (1009).

Referring now to FIG. 11, a block diagram of an illustrative optical receiver (1100) is shown. The illustrative optical receiver (1100) may be configured to receive a modulated optical data from an optical transmitter (1000, FIG. 10). Variations may be made in the components and/or functions thereof as may suit a particular application.

In the present example, optical receiver (1100) may include an optical detector (1101) such as a photodiode or other optical detector (1101) that may suit a particular application. The optical detector (1101) may be configured to receive optical energy and output an electrical signal representative of the optical energy received to an amplifier (1103). The optical detector (1101) may be configured to detect optical energy of a certain characteristic wavelength or band of characteristic wavelengths. Additionally, one or more optical filters may be included in the optical receiver (1100) to filter out optical energy of any wavelength other than the characteristic wavelength or band of characteristic wavelengths being used for data transmission.

The analog signal output by the optical detector (1101) and amplifier (1103) may then be received into an analog-to-digital converter (1107) configured to output a digital representation of the analog signal received. In some embodiments, an automatic gain control module (1105) may be included in the optical receiver (1100) to receive the signal output from the amplifier (1103) and/or the analog-to-digital converter (1107) and provide gain feedback to the amplifier (1103).

This digital representation may be output to a signal adaptive filter (1109) configured to detect instances of the burst of heterogeneous pulses output by the optical source (1003, FIG. 10) of an optical transmitter (1000, FIG. 10). The signal adaptive filter (1109) will be configured to identify pulses of a particular pulse length occurring at a specific frequency. When two or more such pulse trains are identified at specific independent frequencies with the band of characteristic frequencies designated for data transmission, the filter (1109) recognizes a pulse burst that is part of a data-bearing optical signal. In some embodiments, the filter (1109), or the filter (1109) combined with the demodulator (1113), may be described as a “correlator.”

A clock reference module (1111) may provide timing information to the signal data filter (1109). The signal adaptive filter (1109) may include a digital signal processing (DSP) filter, and/or other filter according to the features of a particular application.

A digital signal corresponding to the detected instances of the burst of heterogeneous pulses may be received by a demodulator module (1113) which may then demodulate the transmitted data according to the particular modulation scheme employed. The demodulated data may then be provided to a receiving electronic device.

### Illustrative Methods

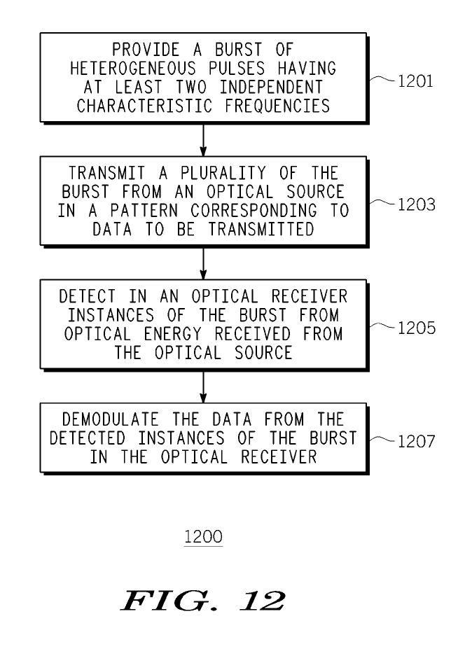

Referring now to FIG. 12, a block diagram is shown of an illustrative method (1200) of optical communication, according to the principles described herein. The illustrative method of (1200) may be performed in complementary transmitting and receiving electronic devices.

The illustrative method (1200) includes the steps of providing (step 1201) a burst of heterogeneous pulses having a frequency spectrum spanning a particular band of frequencies and transmitting (step 1203) a number of such bursts from an optical source in a pattern relative to a time-cycle, where the pattern of bursts within the time-cycle corresponds to data to be transmitted as described above.

The method (1200) may also include the step of detecting (step 1205) in an optical receiver instances of the bursts of optical energy received from the optical source. The detection process (step 1205) may include filtering, amplifying, conditioning, and/or converting an electrical signal produced by an optical detector, such as a photodiode or other optical sensor.

The method (1200) may also include the step of demodulating (step 1207) the transmitted data using the detected instances of the burst relative to the defined time-cycle. This demodulation (step 1207) may occur within an electronic demodulation module associated or in communication with the optical receiver.

In at least some embodiments, the various parameters of the burst pattern, such as vector data, vector length, pulse width etc., can be reprogrammable or selectable as best suits a particular application. In at least some embodiments, a burst vector pattern is generated by a pseudo-random algorithm. For example, the algorithm may be written to produce (1) pseudo random vectors where the probability of a 1 in each position of the vector is 50%; (2) pseudo random vectors where the probability of a 1 in each position of the vector is not 50%; (3) pseudo random vectors where there is a very small or zero correlation between the value in one position of the vector and the other positions; (4) pseudo random vectors where there is a significant non-zero correlation between the value in one position of the vector and the other positions; (5) vectors that are selected to have as wide a spectrum as possible; and (6) vectors that are selected to have an essentially bandwidth-limited spectrum. Additionally, Walsh functions and m-sequences (maximal-length shift register sequences) can be used as vectors.

The processes shown in FIG. 12 and described elsewhere in this specification may be implemented in a general, multi-purpose or single purpose processor. Such a processor will execute instructions, either at the assembly, compiled or machine-level, to perform that process. Those instructions can be written by one of ordinary skill in the art following the description of FIG. 12 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. An optical communication apparatus, said apparatus comprising:
an optical source; and
electronic control circuitry configured to generate a burst of heterogeneous pulses, said burst comprising pulses having a frequency spectrum spanning a particular band of frequencies;
wherein said electronic control circuitry is further configured to transmit a plurality of said bursts from said optical source in a pattern corresponding to data to be transmitted.

2. The optical communication apparatus of claim 1, wherein said optical source comprises at least one or more of: light emitting diodes and lasers.

3. The optical communication apparatus of claim 1, wherein said optical source is configured to transmit infrared light.

4. The optical communication apparatus of claim 1, wherein said electronic control circuitry comprises a burst modulator.

5. The optical communication apparatus of claim 1, wherein said electronic control circuitry is further configured to transmit an inverse of said burst from said optical source during periods in which said burst is not being transmitted from said optical source.

6. An optical communication system, said system comprising:
an optical source configured to transmit a plurality of pulse bursts from said optical source in a pattern corresponding to data to be transmitted; and
an optical receiver configured to receive said plurality of bursts and decode said data from said pattern;
wherein said bursts comprise a plurality of heterogeneous pulses from said optical source, said burst comprising pulses having a frequency spectrum spanning a particular band of frequencies.

7. The optical communication system of claim 6, further comprising control circuitry configured to control said optical source.

8. The optical communication apparatus of claim 6, wherein said electronic control circuitry comprises a burst modulator.

9. The optical communication system of claim 6, wherein said optical receiver comprises at least one photodiode.

10. The optical communication system of claim 6, wherein said optical receiver comprises at least one analog-to-digital converter configured to produce a digital representation of optical energy detected by said optical receiver.

11. The optical communication system of claim 9, further comprising a signal adaptive filter configured to detect instances of said burst in said digital representation.

12. The optical communication apparatus of claim 6, wherein said optical source comprises at least one or more of: light emitting diodes and lasers.

13. The optical communication apparatus of claim 6, wherein said optical source is configured to transmit infrared light.

14. The optical communication apparatus of claim 6, wherein said electronic control circuitry is further configured to transmit an inverse of said burst from said optical source during periods in which said burst is not being transmitted from said optical source.

15. A method of optical communication, said method comprising:
generating a burst of heterogeneous pulses, wherein said burst comprises pulses within a band of characteristic pulse frequencies; and
transmitting a plurality of said bursts from an optical source in a pattern relative to a time cycle, wherein said pattern corresponds to data to be transmitted.

16. The method of claim 15, further comprising transmitting an inverse of said burst from said optical source during periods of said time cycle in which said burst is not being transmitted.

17. The method of claim 15, further comprising receiving said transmission from said optical source in an optical sensor.

18. The method of claim 17, further comprising converting an analog signal obtained from said optical sensor into a digital representation of said transmission.

19. The method of claim 15, further comprising filtering said transmission from said optical source for instances of said burst.

20. The method of claim 19, further comprising demodulating said data from said transmission using said instances of said burst.
